(19) United States
(12) Patent Application Publication
(10) Pub. No.: US 2004/0115544 A1
(43) Pub. Date: Jun. 17, 2004

(54) Imaging member

(75) Inventors: Min-Hong Fu, Webster, NY (US); Colleen A. Helbig, Penfield, NY (US); Kent J. Evans, Lima, NY (US); Kathleen M. Carmichael, Williamson, NY (US); David M. Skinner, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/320,809

(22) Filed: Dec. 16, 2002

(51) Int. Cl. G03G 5/047

(52) U.S. Cl. 430/58.05; 430/133; 399/159; 430/64; 430/65; 430/59.4; 430/59.5; 430/59.1; 430/58.8; 430/58.65; 430/58.75

(57) ABSTRACT

A charge transport layer for an imaging member comprising a charge transport layer wherein the charge transport layer comprises the application of charge transport molecules and a poly(fluoroacrylate)-graft-poly(methyl methacrylate) surfactant. The charge transport layer exhibits excellent wear resistance, excellent electrical performance, excellent print quality and decreased crystallization of the charge transport component.

### BACKGROUND

This invention relates in general to an electrostatographic imaging member comprising a charge transport layer containing a surfactant and wherein the surfactant primarily reduces the undesirable crystallization of the charge transport layer material.

The charge transport layer of a photoreceptor is, in embodiments, capable of supporting the injection of photo-generated holes and electrons from a charge generating layer and allowing the transport of these holes or electrons through the transport layer to selectively discharge the surface charge. If some of the charges are trapped inside the transport layer, the surface charges will not completely discharge and the toner image will not be fully developed on the surface of the photoreceptor

### REFERENCES

In the art of electrophotography, an electrophotographic plate comprising a photoconductive insulating layer on a conductive layer is imaged by first uniformly electrostatically charging the surface of the photoconductive insulating layer. The plate is then exposed to a pattern of activating electromagnetic radiation such as light, which selectively dissipates the charge in the illuminated areas of the photoconductive insulating layer while leaving behind an electrostatic latent image in the non-illuminated areas. This electrostatic latent image may then be developed to form a visible image by depositing finely divided electroscopic toner particles, for example, from a developer composition, on the surface of the photoconductive insulating layer. The resulting visible toner image can be transferred to a suitable receiving member such as paper.

Electrophotographic imaging members are usually multilayered photoreceptors that comprise an optional substrate support, an electrically conductive layer, an optional charge blocking layer, an optional adhesive layer, a charge generating layer, a charge transport layer, and an optional protective or overcoating layer(s). These imaging members can take several forms, including flexible belts, rigid drums, and the like. For a number of multilayered flexible photoreceptor belts, an anticurl layer may be employed on the backside of the substrate support, opposite to the side carrying the electrically active layers, to achieve the desired photoreceptor flatness.

Various combinations of materials for charge generating layers and charge transport layers have been disclosed. U.S. Pat. No. 4,265,990 discloses a layered photoreceptor having a separate charge generating (photogenerating) layer and charge transport layer. The charge generating layer is capable of photogenerating holes and injecting the photogenerated holes into the charge transport layer. The photogenerating layer utilized in multilayered photoreceptors include, for example, inorganic photoconductive particles or organic photoconductive particles dispersed in a film forming polymeric binder. Inorganic or organic photoconductive materials may be formed as a continuous, homogeneous photogenerating layer. The disclosure of this patent is totally incorporated herein by reference.

In multilayer photoreceptor devices, one property of interest, for example, is the crystallization of the transport component. Charge transport component crystallization can occur for example, in charge transport layer mixtures of N,N′-diphenyl-N,N′-bis(alkylphenyl)-1,1-biphenyl-4,4′-diamine or 1,1-bis(di-4-tolyaminophenyl)cyclohexane (TAPC) dispersed in polycarbonate binders and methylene chloride solvent. Phase separation or crystallization is an important factor in the determination of for example, upper limit concentration amount of the transport molecules that can be dispersed in a binder. What is desired is an improved material for a charge transport layer of an imaging member that exhibits excellent performance properties and inhibits crystallization of the charge transport molecules. This is achieved in accordance with the present invention with a surfactant being added to the charge transport layer.

### SUMMARY

Disclosed herein is an electrophotographic imaging member comprising an optional supporting substrate,

an optional charge blocking layer, an optional adhesive layer,

a charge-generating layer,

a charge transporting layer comprising a charge transport component and a poly(fluoroacrylate)-graft-poly(methyl methacrylate) surfactant,

an optional anticurl layer, and

a binder.

Also disclosed is a charge transporting compound for use in a charge transport layer of an imaging member, and a charge transport layer surfactant that minimizes crystallization of the charge transport component.

With the disclosed poly(fluoroacrylate)-graft-poly(methyl methacrylate) surfactant, there is for example, achieved an imaging member with excellent charge transporting performance, minimized crystallization of the charge transport component, and improved wear resistance.

The charge transport layer of a photoreceptor is, in embodiments, capable of supporting the injection of photo-generated holes and electrons from a charge generating layer and allowing the transport of these holes or electrons through the transport layer to selectively discharge the surface charge. If some of the charges are trapped inside the transport layer, the surface charges will not completely discharge and the toner image will not be fully developed on the surface of the photoreceptor. In specific embodiments, the surfactant comprises poly(fluoroacrylate)-graft-poly(methyl methacrylate), GF-300, available from Toagosei Chemical Industries and having a weight average molecular weight of about 25,000. For example, in embodiments the charge transport layer comprises from about 20 to about 80 percent by weight of at least one charge transport material and about 0.01 to about 0.2 percent by weight of the surfactant. In a more specific embodiment, the surfactant is present in an amount of from about 0.03 to about 0.15 percent by weight of the charge transport components. The dried charge transport layer can contain from about 30 percent to and about 70 percent by weight of a charge transport component or components based on the total weight of the dried charge transport layer.

The charge transport layer material may also include additional additives, such as, for example, an IRGANOX® antioxidant, a hindered phenol in an amount for example, of from about 3 to about 50 percent by weight, and more specifically from about 4 to about 20 percent by weight and wear resistant additives such as, polytetrafluoroethylene (PTFE) particles.

The solvent can be included as a further component of the charge transport layer. With the present invention embodiments, the charge transport layer can be formed economically and less costly than with some conventional polycarbonate binder resins. The solvent can be included as a further charge transport layer component in the preparation thereof and can comprise tetrahydrofuran, toluene, methylene chloride and the like. The solvent may be present in the charge transport layer in an amount from about 80 to about 90 weight percent.

In embodiments, the charge transport layer may be any suitable arylamine hole transporter molecule as follows:

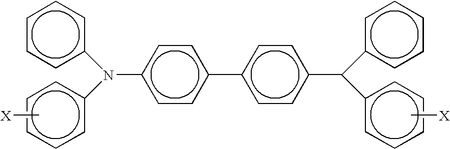

wherein X is selected from the group consisting of alkyl and halogen. Typically, the halogen is a chloride. Alkyl typically for example, from 1 to about 10 carbon atoms and, in embodiments, from 1 to about 5 carbon atoms. Examples of specific aryl amines include, for example, N,N′-diphenyl-N,N′-bis(alkylphenyl)-1,1-biphenyl-4,4′-diamine wherein alkyl is selected from the group consisting of methyl, ethyl, propyl, butyl, hexyl, and the like; and N,N′-diphenyl-N,N′-bis(halophenyl)-1,1′-biphenyl-4,4′-diamine and wherein the halo substituent is preferably a chloro substituent. Other specific examples of aryl amines include, 9-9-bis(2-cyanoethyl)-2,7-bis(phenyl-m-tolylamino)fluorene, tritolylamine, N,N′-bis(3,4-dimethylphenyl)-N″(1-biphenyl)amine, 2-bis((4′-methylphenyl)amino-p-phenyl) 1,1-diphenyl ethylene, 1-bisphenyl-diphenylamino-1-propene, 1,1-bis(di-4-tolyamino-phenyl)cyclohexane (TAPC), and the like.

In embodiments, the charge transport layer is formed upon a charge generating layer wherein for example, charge transport components, such as N,N′-diphenyl-N,N′-bis(3-methylphenyl)-[1,1′-biphenyl]-4,4′diamine and a polymer binder, for example, a polycarbonate, like MAKROLON®, are applied during the first pass. During the second pass, a charge transport component or compound, such as N,N′-diphenyl-N,N′-bis(3-methylphenyl)-[1,1′-biphenyl]-4,4′diamine, poly(fluoroacrylate)-graft-poly(methyl methacrylate), and a polymer binder dissolved in a solvent are deposited to complete the charge transport layer. Any suitable and conventional techniques may be utilized to apply the charge transport layer coating solution to the photoreceptor structure. Typical application techniques include, for example, spraying, dip coating, extrusion coating, roll coating, wire wound rod coating, draw bar coating, and the like.

The dried charge transport layer has in embodiments a thickness of from about 5 to about 500 micrometers and more specifically has a thickness of, for example, from about 10 micrometers to about 50 micrometers. In general, the ratio of the thickness of the charge transport layer to the charge generating layer is in embodiments maintained from about 2:1 to about 200:1, and in some instances about 400:1 and which charge transport layer possesses excellent wear resistance.

The charge generating layer, charge transport layer, and other layers may be applied in any suitable order to produce either positive or negative charging photoreceptors. For example, the charge generating layer may be applied prior to the charge transport layer, as illustrated in U.S. Pat. No. 4,265,990, or the charge transport layer may be applied prior to the charge generating layer, as illustrated in U.S. Pat. No. 4,346,158, the entire disclosures of these patents being totally incorporated herein by reference. In embodiments, however, the charge transport layer is deposited upon a charge generating layer in one pass or several passes, and the charge transport layer may optionally be overcoated with an overcoat and/or protective layer.

The photoreceptor substrate may be opaque or substantially transparent, and may comprise any suitable organic or inorganic material having the requisite mechanical properties. The substrate can be formulated entirely of an electrically conductive material, or it can be an insulating material including inorganic or organic polymeric materials, such as MYLAR®, a commercially available polymer, MYLAR® coated titanium, a layer of an organic or inorganic material having a semiconductive surface layer, such as, indium tin oxide, aluminum, titanium, and the like, or exclusively made up of a conductive material such as, aluminum, chromium, nickel, brass, and the like. The substrate may be flexible, seamless or rigid, and may have a number of many different configurations, such as, for example, a plate, a drum, a scroll, an endless flexible belt, and the like. In one embodiment, the substrate is in the form of a seamless flexible belt. The back of the substrate, particularly when the substrate is a flexible organic polymeric material, may optionally be coated with a conventional anticurl layer having an electrically conductive surface. The thickness of the substrate layer depends on numerous factors, including mechanical performance and economic considerations. The thickness of this layer may range from about 25 micrometers to about 1,000 micrometers, and in embodiments from about 50 micrometers to about 500 micrometers for optimum flexibility and minimum induced surface bending stress when cycled around small diameter rollers, for example, 19 millimeter diameter rollers. The surface of the substrate layer is in embodiments cleaned prior to coating to promote greater adhesion of the deposited coating composition. Cleaning may be effected by, for example, exposing the surface of the substrate layer to plasma discharge, ion bombardment, and the like methods. Similarly, the substrate can be either rigid or flexible. In embodiments, the thickness of this layer is from about 3 millimeters to about 10 millimeters. For flexible belt imaging members, for example, the substrate may be from about 65 to about 150 microns thick, and in embodiments from about 75 to about 100 microns thick for optimum flexibility and minimum stretch when cycled around small diameter rollers of, for example, 19 millimeter diameter. The entire substrate can comprise the same material as that in the electrically conductive surface or the electrically conductive surface can be merely a coating on the substrate. Any suitable electrically conductive material can be employed. Typical electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like.

The conductive layer of the substrate can vary in thickness over substantially wide ranges depending on the desired use of the electrophotoconductive member. Generally, the conductive layer ranges in thickness from about 50 Angstroms to many centimeters, although the thickness can be outside of this range. When a flexible electrophotographic imaging member is desired, the thickness of the conductive layer typically is from about 20 Angstroms to about 750 Angstroms, and in embodiments from about 100 to about 200 Angstroms for an optimum combination of electrical conductivity, flexibility, and light transmission. A charge blocking layer may then optionally be applied to the substrate. Generally, electron blocking layers for positively charged photoreceptors allow the photogenerated holes in the charge generating layer at the surface of the photoreceptor to migrate toward the charge (hole) transport layer below and reach the bottom conductive layer during the electrophotographic imaging processes. Thus, an electron blocking layer is normally not expected to block holes in positively charged photoreceptors, such as photoreceptors coated with a charge generating layer over a charge (hole) transport layer. For negatively charged. photoreceptors, any suitable hole blocking layer capable of forming an electronic barrier to holes between the adjacent photoconductive layer and the underlying zirconium or titanium layer may be utilized. A hole blocking layer may comprise any suitable material such as polymers, such as polyvinylbutyral, epoxy resins, polyesters, polysiloxanes, polyamides, polyurethanes, and the like, or such a layer may be comprised of nitrogen containing siloxanes or nitrogen containing titanium compounds, such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylamino-ethylamino)titanate, isopropyl trianthranil titanate, isopropyl tri(N,N-dimethyl-ethylamino)titanate, titanium-4-amino benzene sulfonate oxyacetate, titanium 4-aminobenzoate isostearate oxyacetate, [H₂N(CH₂)₄]CH₃Si(OCH₃)₂, gamma-aminobutyl) methyl diethoxysilane, and [H₂N(CH₂)₃]CH₃Si(OCH₃)₂, (gamma-aminopropyl)-methyl diethoxysilane, as disclosed in U.S. Pat. Nos. 4,338,387, 4,286,033 and 4,291,110. Other suitable charge blocking layer polymer compositions are also described in U.S. Pat. No. 5,244,762. These include vinyl hydroxyl ester and vinyl hydroxy amide polymers wherein the hydroxyl groups have been partially modified to benzoate and acetate esters that modified polymers are then blended with other unmodified vinyl hydroxy ester and amide unmodified polymers. An example of such a blend is a 30 mole percent benzoate ester of poly(2-hydroxyethyl methacrylate) blended with the parent polymer poly(2-hydroxyethyl methacrylate). Still other suitable charge blocking layer polymer compositions are described in U.S. Pat. No. 4,988,597

The blocking layer is continuous and may have a thickness of less than about 10 micrometers. In embodiments, a blocking layer of from about 0.005 micrometers to about 1.5 micrometers facilitates charge neutralization after the exposure step and optimum electrical performance is achieved. The blocking layer may be applied by any suitable conventional technique such as, spraying, dip coating, draw bar coating, gravure coating, silk screening, air knife coating, reverse roll coating, vacuum deposition, chemical treatment, and the like. For convenience in obtaining thin layers, the blocking layer is, in embodiments, applied in the form of a dilute solution, with the solvent being removed after deposition of the coating by conventional techniques such as, by vacuum, heating, and the like. Generally, a weight ratio of blocking layer material and solvent of between about 0.05:100 to about 5:100 is satisfactory for spray coating.

If desired, an optional adhesive layer may be formed on the substrate. Any suitable solvent may be used to form an adhesive layer coating solution. Typical solvents include tetrahydrofuran, toluene, hexane, cyclohexane, cyclohexanone, methylene chloride, 1,1,2-trichloroethane, monochlorobenzene, and the like, and mixtures thereof. Any suitable technique may be utilized to apply the adhesive layer coating. Typical coating techniques include extrusion coating, gravure coating, spray coating, wire wound bar coating, and the like. The adhesive layer is applied directly to the charge blocking layer. Thus, the adhesive layer is in embodiments in direct contiguous contact with both the underlying charge blocking layer and the overlying charge generating layer to enhance adhesion bonding and to effect ground plane hole injection suppression. Drying of the deposited coating may be effected by any suitable conventional process such as, oven drying, infrared radiation drying, air drying, and the like. More specifically, the adhesive layer has a thickness of for example, from about 0.01 micrometers to about 2 micrometers after drying. In embodiments, the dried thickness is from about 0.03 micrometers to about 1 micrometer.

The components of the photogenerating layer comprise photogenerating particles for example, of Type V hydroxygallium phthalocyanine, x-polymorph metal free phthalocyanine, chlorogallium phthalocyanine, titanyl phthalocyanines, and perylene photogenerating pigments dispersed in a matrix comprising an arylamine hole transport molecules and certain selected electron transport molecules. Type V hydroxygallium phthalocyanine is well known and has X-ray powder diffraction (XRPD) peaks at, for example, Bragg angles (2 theta +/−0.2°) of 7.4, 9.8, 12.4, 16.2, 17.6, 18.4, 21.9, 23.9, 25.0, 28.1, with the highest peak at 7.4 degrees. The X-ray powder diffraction traces (XRPDs) were generated on a Philips X-Ray Powder Diffractometer Model 1710 using X-radiation of CuK-alpha wavelength (0.1542 nanometer). The diffractometer was equipped with a graphite monochrometer and pulse-height discrimination system. Two-theta is the Bragg angle commonly referred to in x-ray crystallographic measurements. I (counts) represents the intensity of the diffraction as a function of Bragg angle as measured with a proportional counter. Type V hydroxygallium phthalocyanine may be prepared by hydrolyzing a gallium phthalocyanine precursor including dissolving the hydroxygallium phthalocyanine in a strong acid and then reprecipitating the resulting dissolved precursor in a basic aqueous media; removing any ionic species formed by washing with water; concentrating the resulting aqueous slurry comprising water and hydroxygallium phthalocyanine as a wet cake; removing water from the wet cake by drying; and subjecting the resulting dry pigment to mixing with a second solvent to form the Type V hydroxygallium phthalocyanine. These pigment particles in embodiments have an average particle size of less than about 5 micrometers.

Layer thicknesses for the photogenerating layer are for example, from about 0.05 micrometers to about 100 micrometers may be satisfactory and, in embodiments, from about 0.05 micrometers to about 40 micrometers thick. The photogenerating binder layer containing photoconductive compositions and/or pigments, and the resinous binder material in embodiments, ranges in thickness of from about 0.1 micrometers to about 5 micrometers, and more specifically possesses a thickness of from about 0.3 micrometers to about 3 micrometers for excellent light absorption and improved dark decay stability and excellent mechanical properties.

When the photogenerating material is present in the binder material, the photogenerating composition or pigment may be present in the film forming polymer binder compositions in any suitable or desired amounts. For example, from about 10 percent by volume to about 60 percent by volume of the photogenerating pigment may be dispersed in from about 40 percent by volume to about 90 percent by volume of the film forming polymer binder composition, and in embodiments from about 20 percent by volume to about 30 percent by volume of the photogenerating pigment may be dispersed in about 70 percent by volume to about 80 percent by volume of the film forming polymer binder composition. Typically, the photoconductive material is present in the photogenerating layer in an amount of from about 5 to about 80 percent by weight, and in embodiments from about 25 to about 75 percent by weight, and the binder is present in an amount of from about 20 to about 95 percent by weight, and in embodiments from about 25 to about 75 percent by weight, although the relative amounts can be outside these ranges. The photogenerating layer containing photoconductive compositions and the resinous binder material generally ranges in thickness from about 0.05 microns to about 10 microns or more and, in embodiments, from about 0.1 microns to about 5 microns, and in more specific embodiments having a thickness of from about 0.3 microns to about 3 microns, although the thickness may be outside these ranges. The photogenerating layer thickness is related to the relative amounts of photogenerating compound and binder, with the photogenerating material often being present in amounts of from about 5 to about 100 percent by weight. Higher binder content compositions generally require thicker layers for photogeneration. Generally, it is desirable to provide this layer in a thickness sufficient to absorb about 90 percent or more of the incident radiation which is directed upon it in the imagewise or printing exposure step. The maximum thickness of this layer is dependent primarily upon factors such as mechanical considerations, the specific photogenerating compound selected, the thicknesses of the other layers, and whether a flexible photoconductive imaging member is desired. The photogenerating layer can be applied to underlying layers by any desired or suitable method. Any suitable technique may be utilized to mix and thereafter apply the photogenerating layer coating mixture. Typical application techniques include spraying, dip coating, roll coating, wire wound rod coating, and the like. Drying of the deposited coating may be effected by any suitable technique, such as, oven drying, infrared radiation drying, air drying, and the like.

Any suitable film forming binder may be utilized in the photoconductive insulating layer. Examples of suitable binders for the photoconductive materials of the photogenerating layer include thermoplastic and thermosetting resins, such as polycarbonates,: polyesters, including polyethylene terephthalate, polyurethanes, polystyrenes, polybutadienes, polysulfones, polyarylethers, polyarylsulfones, polyethersulfones, polycarbonates, polyethylenes, polypropylenes, polymethylpentenes, polyphenylene sulfides, polyvinyl acetates, polyvinylbutyrals, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchlorides, polyvinyl alcohols, poly-N-vinylpyrrolidinone), vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and the like.

Specific electrically inactive binders for the photogenerating layer include poly(4,4′-isopropylidene diphenyl) carbonate, poly(4,4′-diphenyl-1,1′-cyclohexane carbonate) polycarbonate; poly(4,4′-diphenyl-1,1′-cyclohexane carbonate-500, with a weight average molecular weight of 51,000; or poly(4,4′-diphenyl-1,1′-cyclohexane carbonate-400, with a weight average molecular weight of about 40,000.

The charge transport layer not only serves to transport holes or electrons, but also protects the photoconductive layer from abrasion or chemical attack. The charge transport layer is normally transparent in a wavelength region in which the electrophotographic imaging member is to be used when exposure is effected therethrough to ensure that most of the incident radiation is utilized by the underlying charge generating layer. The charge transport layer should exhibit negligible charge generation, and discharge if any, when exposed to a wavelength of light useful in xerography, e.g., 4000 to 9000 Angstroms. When used with a transparent substrate, imagewise exposure or erase may be accomplished through the substrate with all light passing through the substrate. In this case, the charge transport material need not transmit light in the wavelength region of use if the charge generating layer is sandwiched between the substrate and the charge transport layer. The charge transport layer in conjunction with the charge generating layer is an insulator to the extent that an electrostatic charge placed on the charge transport layer is not conducted in the absence of illumination. The charge transport layer should trap minimal charges either holes, for a negatively charged system or electrons, for a positively charged system. Charge transport layer materials are well known in the art.

The charge transport layer may, for example, comprise activating compounds or charge transport molecules dispersed in normally, electrically inactive film forming polymeric materials for making these materials electrically active. These charge transport molecules may be added to polymeric materials which are incapable of supporting the injection of photogenerated holes and incapable of allowing the transport of these holes.

In embodiments, an arylamine charge hole transporter molecule may be represented by:

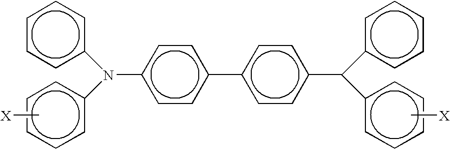

wherein X is selected from the group consisting of alkyl and halogen. Typically, the halogen is a chloride. The alkyl typically contains from 1 to about 10 carbon atoms, and in embodiments from 1 to about 5 carbon atoms. Typical aryl amines include, for example, N,N′-diphenyl-N,N′-bis(alkylphenyl)-1,1-biphenyl-4,4′-diamine wherein alkyl is selected from the group consisting of methyl, ethyl, propyl, butyl, hexyl, and the like; and N,N′-diphenyl-N,N′-bis(halophenyl)-1,1′-biphenyl-4,4′-diamine wherein the halo substituent is preferably a chloro substituent. Other specific examples of aryl amines include, 9-9-bis(2-cyanoethyl)-2,7-bis(phenyl-m-tolylamino)fluorene, tritolylamine, N,N′-bis(3,4-dimethylphenyl)-N″(1-biphenyl)amine, 2-bis((4′-methylphenyl)amino-p-phenyl) 1,1-diphenyl ethylene, 1-bisphenyl-diphenylamino-1-propene, 1,1-bis(di-4-tolyamino-phenyl)cyclohexane (TAPC), and the like.

In embodiments, the charge transport layer is comprised of N,N′-diphenyl-N,N′-bis(alkylphenyl)-1,1-biphenyl-4,4′-diamine, poly(fluoroacrylate)-graft-poly(methyl methacrylate) in tetrahydrofuran and a polymer binder. In a further specific embodiment, the charge transport layer comprises a mixture of 1,1-bis(di-4-tolyaminophenyl)cyclohexane (TAPC) in toluene and a polymer binder. In a specific embodiment, the charge transport layer comprises from about 25 to about 75 percent by weight of at least one charge transporting aromatic amine compound, and about 75 to about 25 percent by weight of a polymeric film.

Optionally, an overcoat layer and/or a protective layer can also be utilized to improve resistance of the photoreceptor to abrasion. In some cases, an anticurl back coating may be applied to the surface of the substrate opposite to that bearing the photoconductive layer to provide flatness and/or abrasion resistance where a web configuration photoreceptor is fabricated. These overcoating and anticurl back coating layers are well known in the art, and can comprise thermoplastic organic polymers or inorganic polymers that are electrically insulating or slightly semiconductive. Overcoatings can be continuous and typically have a thickness of less than about 10 microns, although the thickness can be outside this range. The thickness of anticurl backing layers generally is sufficient to balance substantially the total forces of the layer or layers on the opposite side of the substrate layer. An example of an anticurl backing layer is described in U.S. Pat. No. 4,654,284, the disclosure of which is totally incorporated herein by reference. A thickness of from about 70 to about 160 microns is a typical range for flexible photoreceptors, although the thickness can be outside this range. An overcoat can have a thickness of at most 3 microns for insulating matrices and at most 6 microns for semi-conductive matrices.

The imaging members of the present invention can be utilized in an electrophotographic imaging process, by for example, first uniformly electrostatically charging the photoreceptor, then exposing the charged photoreceptor to a pattern of activating electromagnetic radiation such as light, which selectively dissipates the charge in the illuminated areas of the photoreceptor while leaving behind an electrostatic latent image in the non-illuminated areas. This electrostatic latent image may then be developed at one or more developing stations to form a visible image by depositing finely divided electroscopic toner particles, for example, from a developer composition, on the surface of the photoreceptor. The resulting visible toner image can be transferred to a suitable receiving member such as paper. The photoreceptor is then typically cleaned at a cleaning station prior to being re-charged for formation of subsequent images.

### COMPARATIVE EXAMPLE 1

A coating solution was prepared by first dissolving 5 grams of N,N′-diphenyl-N,N′-bis(alkylphenyl)-1,1-biphenyl-4,4′-diamine in methylene chloride and the resulting mixture was stirred for 15-30 minutes. A poly(fluoroacrylate)-graft-poly(methyl methacrylate) (GF-300) surfactant was added to the mixture. Five grams of MAKROLON 5705® polycarbonate binder was added and the mixture was placed on shaker and stirred for 5 hours. The resulting coating solution contains 15.0 percent solid N,N′-diphenyl-N,N′-bis(alkylphenyl)-1,1-biphenyl-4,4′-diamine & MAKROLON®) based on N,N′-diphenyl-N,N′-bis(alkylphenyl)-1,1-biphenyl-4,4′-diamine, MAKROLON® and methylene chloride.

The above charge transport coating solution was coated on an imaging member web. This imaging member web comprises a polyethylene naphthalate (PEN) based substrate having a thickness of 88.9 micrometers with 400-600 Angstrom units thick of a gamma aminopropylthiethoxysilane blocking layer, followed by 350-450 Angstrom units thick of an E. I. DuPont 49,000 polyester adhesive layer and approximately 0.4 micrometer of a hydroxygallium phthalocyanine charge generator layer. The coatings were made using a 0.0045″ bird bar applicator for a single pass charge transport layer, or with a 0.002″ bird bar for a 2-pass charge transport layer. The coatings were air dried for about 5 minutes before oven drying for about 1 minute at 120 degrees Celsius after each pass. The overall charge transport layer coating thickness is about 29 microns.

The device was electrically tested with an electrical scanner set to obtain photoinduced discharge cycles. The scanner was equipped with a scorotron set to a constant voltage charging at various surface potentials. The exposure light source was a 780 nanometer light emitting diode. The xerographic simulation was completed in an environmentally controlled light tight chamber at ambient conditions (40 percent relative humidity and 22 degree Celsius).

After heat stress the coating device at 140 degrees Celsius for 30 minutes, a dense m-TBD crystal network was observed growing in both size and density with heat stress time. Nikon Optiphot microscope at 200 or 400× magnification was used for the observation.

### EXAMPLE II

A coating solution was prepared by first dissolving 5 grams of N,N′-diphenyl-N,N′-bis(alkylphenyl)-1,1-biphenyl-4,4′-diamine in methylene chloride and the mixture was stirred for 15-30 minutes. To this mixture was added 0.02 grams of the poly(fluoroacrylate)-graft-poly(methyl methacrylate) (GF-300) surfactant and the resulting mixture was stirred for 10 minutes. Finally, to this mixture was added 5 grams of MAKROLON 5705® polycarbonate binder and the mixture was placed on shaker and stirred for 5 hours. The coating solution contains 15.06 percent solids, N,N′-diphenyl-N,N′-bis(alkylphenyl)-1,1-biphenyl-4,4′-diamine, 0.2 weight percent of the poly(fluoroacrylate)-graft-poly(methyl methacrylate) surfactant and MAKROLON® based on N,N′-diphenyl-N,N′-bis(alkylphenyl)-1,1-biphenyl-4,4′-diamine, poly(fluoroacrylate)-graft-poly(methyl methacrylate), MAKROLON® and methylene chloride.

The above charge transport coating solution was coated on an imaging member web. This imaging member web comprises a polyethylene naphthalate (PEN) based substrate having a thickness of 88.9 micrometers with a 400-600 Angstrom units thick of a gamma aminopropylthiethoxysilane blocking layer, followed by 350-450 Angstrom units thick of the above E. I. du Pont 49,000 polyester adhesive layer and approximately 0.4 micrometer of hydroxygallium phthalocyanine charge generator layer. The charge transport layer was made using a 0.0045″ bird bar applicator for a single pass charge transport layer, or 0.002″ bird bar for a 2 pass charge transport layer. The coatings were air dried for about 5 minutes before oven drying for about 1 minute at 120 degrees Celsius after each pass. The overall charge transport layer thickness was about 29 microns.

The device was electrically tested with an electrical scanner set to obtain photoinduced discharge cycles. The scanner was equipped with a scorotron set to a constant voltage charging at various surface potentials. The exposure light source was a 780 nanometer light emitting diode. The xerographic simulation was completed in an environmentally controlled light tight chamber at ambient conditions (40 percent relative humidity and 22 degree Celsius). Similar electrical properties were obtained as that for the device in Example I.

After heat stress the coating device at 140 degrees Celsius for 30 minutes, significantly less m-TBD crystallization was observed under a Nikon Optiphot microscope at 200 or 400× magnification.

### EXAMPLE III

A coating solution was prepared by first dissolving 0.02 grams of the poly(fluoroacrylate)-graft-poly(methyl methacrylate) (GF-300) surfactant in methylene chloride and the mixture was stirred for 15 minutes. Finally, to this mixture was added 5 grams of MAKROLON 5705® polycarbonate binder and the mixture was placed on shaker and stirred for 5 hours. The coating solution contains 15.06 percent solid (N,N′-diphenyl-N,N′-bis(alkylphenyl)-1,1-biphenyl-4,4′-diamine, poly(fluoroacrylate)-graft-poly(methyl methacrylate) & MAKROLON®) based on 0.4 weight percent GF-300, MAKROLON® and methylene chloride

The above charge transport coating solution was coated on an imaging member web. This imaging member web comprises a polyethylene naphthalate (PEN) based substrate having a thickness of 88.9 micrometers with 400-600 Angstrom units thick of a gamma aminopropylthiethoxysilane blocking layer, followed by 350-450 Angstrom units thick of 49,000 polyester adhesive layer and approximately 0.4 micrometer of a hydroxygallium phthalocyanine charge generator layer. The coatings were made using a 0.0045″ bird bar applicator for a single pass charge transport layer with a 15 percent solids solution, or 0.002″ bird. bar for a 2 pass, 7.55 percent solids solution. The coatings were air dried for about 5 minutes before oven drying for about 1 minute at 120 degrees Celsius after each pass. The overall charge transport thickness was about 29 microns.

After heat stress at 140 degrees Celsius for 30 minutes, no crystallization was measured by a Nikon Optiphot microscope at 200× and 400× magnification with the above Comparative Example heat stress times.

The photoreceptor of the present invention may be charged using any conventional charging apparatus, which may include, for example, an AC bias charging roll (BCR), see, for example, U.S. Pat. No. 5,613,173, the disclosure of which is totally incorporated herein by reference in its entirety. Charging may also be effected by other known methods, for example, utilizing a corotron, dicorotron, scorotron, pin charging device, and the like.

Although the invention has been described with reference to specific embodiments, it is not intended to be limited thereto. Rather, those having ordinary skill in the art will recognize that variations and modifications, including equivalents, substantial equivalents, similar equivalents, and the like may be made therein which are within the spirit of the invention and within the scope of the claims.

What is claimed is:

1. An imaging member comprising:
a charge generating layer,
a charge transport layer comprised of charge transport components and a poly(fluoroacrylate)-graft-poly(methyl methacrylate) surfactant,
and a polymer binder.

2. An imaging member comprising:
a supporting substrate,
a charge blocking layer,
a charge generating layer,
a first and a second charge transport layer wherein the first charge transport layer comprises a charge transport component and a polymer binder and wherein the second charge transport layer comprises a charge transport component and a poly(fluoroacrylate)-graft-poly(methyl methacrylate) surfactant.

3. An imaging member comprising:
a supporting substrate,
a charge blocking layer,
a charge generating layer,
a charge transport layer wherein the charge transport layer comprises a charge transport component and a poly(fluoroacrylate)-graft-poly(methyl methacrylate) surfactant.

4. An imaging member according to claim 1, wherein said poly(fluoroacrylate)-graft-poly(methyl methacrylate) surfactant has a weight average molecular weight of from about 25,000.

5. An imaging member according to claim 1, wherein the charge transport component comprises an arylamine represented by: 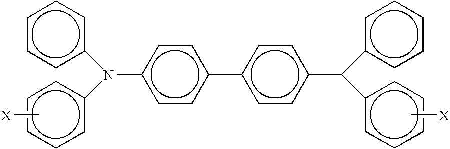
wherein X is selected from the group consisting of alkyl and halogen.

6. An imaging member according to claim 1, and wherein said charge transport components are comprised of an arylamine selected from the group consisting of, N,N′-diphenyl-N,N′-bis(alkylphenyl)-1,1-biphenyl-4,4′-diamine, N,N′-diphenyl-N,N′-bis(halophenyl)-1,1′-biphenyl-4,4′-diamine, 9-9-bis(2-cyanoethyl)-2,7-bis(phenyl-m-tolylamino)fluorene, tritolylamine, N,N′-bis(3,4-dimethylphenyl)-N″(1-biphenyl)amine, 2-bis((4′-methylphenyl)amino-p-phenyl) 1,1-diphenyl ethylene, and 1-bisphenyl-diphenylamino-1-propene.

7. An imaging member according to claim 1 wherein the charge transport component is N,N′-diphenyl-N,N′-bis(alkylphenyl)-1,1-biphenyl-4,4′-diamine.

8. An imaging member according to claim 1 wherein the charge transport component is 1,1-bis(di-4-tolyaminophenyl)cyclohexane.

9. An imaging member according to claim 1 wherein the charge transport components are dispersed in a solvent comprising tetrahydrofuran, methylene chloride or toluene.

10. An imaging member according to claim 1 wherein the charge transport components are dispersed in a solvent comprising tetrahydrofuran.

11. An imaging member according to claim 1 wherein the charge transport components are is dispersed in a solvent comprising toluene.

12. An imaging member according to claim 1 wherein the charge transport components are dispersed in a solvent comprising methylene chloride.

13. An imaging member according to claim 1 wherein said charge transport layer comprises said binder in an amount of from about 20 to about 80 percent by weight.

14. An imaging member according to claim 1 wherein the charge transport layer comprises said charge transport component in an amount of from about 20 to about 80 percent by weight.

15. An imaging member according to claim 1 wherein the charge transport layer comprises said charge transport components in an amount of from about 10 to about 70 percent by weight.

16. An imaging member according to claim 1 wherein the charge transport layer contains charge transport molecules of N,N′-diphenyl-N,N′-bis(alkylphenyl)-1,1-biphenyl-4,4′-diamine in an amount of from about 10 to about 70 weight percent based on the total weight of the charge transport layer components.

17. An imaging member according to claim 1 further comprising an adhesive layer and an overcoat layer.

18. An image forming device comprising at least a photoreceptor and a charging device which charges the photoreceptor, wherein the photoreceptor comprises,
a charge generating layer,
a charge transport layer, and wherein the charge transport layer comprises a charge transport component, poly(fluoroacrylate)-graft-poly(methyl methacrylate) surfactant, and a binder.

19. The image forming device according to claim 18 wherein the photoreceptor is in the form of a belt.

20. The image forming device according to claim 18 wherein the photoreceptor is in the form of a drum.

21. The image forming device according to claim 18 and further comprising a hole blocking layer, an adhesive layer, and an overcoat layer.

22. An imaging member according to claim 1 and further including a substrate of a thickness of from about 50 micrometers to about 1,000 micrometers.

23. An imaging member according to claim 22 wherein said substrate has a thickness of from about 80 to about 120 micrometers.

24. An imaging member according to claim 1 wherein said charge blocking layer comprises zinc oxide, titanium oxide, silica, polyvinyl butyral, and phenolic resins.

25. An imaging member according to claim 1 wherein said charge blocking layer has a thickness of from about 2 micrometers to about 4 micrometers.

26. An imaging member according to claim 1 wherein said charge generating layer comprises Type V hydroxygallium phthalocyanine, chlorogallium phthalocyanine, x-polymorph metal-free phthalocyanine, vanadyl phthalocyanine, or trigonal selenium photogenerating pigments dispersed in a matrix comprising an arylamine hole transport component and certain selected electron transport components.

27. An imaging member according to claim 1 wherein said charge generating layer comprises hydroxygallium phthalocyanine.

28. An imaging member according to claim 1 wherein said charge generating layer has a thickness of from about 3 to about 50 micrometers.
